(19) United States
(12) Patent Application Publication
(10) Pub. No.: US 2026/0350703 A1
(43) Pub. Date: Nov. 5, 2026

(54) HARDWARE-ATTESTED FEDERATED STACK ORCHESTRATOR FOR PREDICTION MARKETS

(71) Applicant: George William Bickerstaff, III, Greenwich, CT (US)

(72) Inventor: George William Bickerstaff, III, Greenwich, CT (US)

(21) Appl. No.: 19/713,887

(22) Filed: Jun. 19, 2026

(51) Int. Cl. G06Q 40/04

(52) U.S. Cl. CPC G06Q 40/042

(57) ABSTRACT

A hardware-attested orchestrator coordinates, at a single regulated prediction market venue, a federated stack of companion compliance systems within a trusted execution environment. The orchestrator ingests attested outputs from Oracle Resolution, trade-integrity (HATIS), confidence-scoring (VPCS), and regulatory-wrapper (RCW) companions, validates each against its hardware-vendor attestation service, and binds them into a composite attestation chain. A cross-layer consistency engine enforces a committed constraint rule set sealed to the hardware, including resolution-timestamp alignment, downweighting of participants flagged by the VPCS-computed insider-risk indicator derived from HATIS signals, equality of confidence-scoring inputs across capital mapping and reporting, and jurisdictional correspondence. The orchestrator emits a master attestation quote binding the chain, consistency result, and unified stack output, independently verifiable by a regulator or institutional counterparty against the orchestrator and each companion without reliance on the venue operator.

### CROSS-REFERENCE TO RELATED APPLICATIONS

This application claims the benefit of U.S. Provisional Application No. 64/044,144, filed Apr. 20, 2026, the entire contents of which are incorporated herein by reference. This application is related to commonly-owned co-pending applications directed to companion systems including a resolution-outcome oracle (Oracle Resolution), a hardware-attested trade integrity system (HATIS), a verified prediction confidence scoring engine (VPCS), and a regulatory-compliant wrapper system (RCW), and to a multi-exchange consolidated platform (MECP) that federates a plurality of orchestrators across venues, the contents of which are incorporated herein by reference to the extent consistent herewith.

### FIELD OF THE INVENTION

The present invention relates to regulated financial market infrastructure, and more particularly to a hardware-attested orchestrator that, at a single regulated prediction market venue, ingests the attested outputs of a plurality of companion compliance systems, enforces cross-layer consistency among them within a hardware trusted execution environment, and produces a single, independently verifiable master attestation over the venue's federated compliance stack.

### BACKGROUND OF THE INVENTION

Regulated prediction market venues must satisfy compliance obligations spanning resolution integrity, trade-integrity surveillance, probability scoring, capital treatment, and regulatory reporting. These functions are increasingly performed by distinct hardware-attested companion systems. However, the attested outputs of these companion systems are produced independently, and no mechanism ensures that they are mutually consistent —that the resolution oracle, the trade-integrity surveillance, the probability scoring, and the capital/reporting wrapper all agree, on the same participants and contracts, within a single hardware-attested boundary.

A software-only orchestrator affords a relying party no cryptographic means of confirming that cross-layer consistency was enforced correctly, on unaltered companion inputs, by unmodified code. A clear need exists for a hardware-attested orchestrator that, at a single venue, validates each companion's attestation quote, enforces a committed set of cross-layer consistency constraints within a hardware-protected enclave, and emits a single master attestation that a regulator or institutional counterparty can verify independently—against the orchestrator's hardware-vendor attestation service and, through a composite chain, against each companion's—without relying on the venue operator. The present invention addresses this need.

### SUMMARY OF THE INVENTION

The invention is directed to a hardware-attested federated stack orchestrator comprising an orchestration engine, a plurality of companion intake interfaces, a companion validation module, a cross-layer consistency engine, and an orchestration attestation module, each executing within a hardware trusted execution environment (TEE), operating at a single regulated prediction market venue.

In one aspect, the orchestrator ingests attested output records from Oracle Resolution, HATIS, VPCS, and RCW companion applications operating at the single venue; validates each companion attestation quote against the corresponding hardware-vendor attestation service; performs real-time cross-layer consistency verification against a committed constraint rule set sealed to the hardware identity of the TEE—enforcing at least Oracle/HATIS timestamp alignment, downweighting of VPCS contributions for participants flagged by the VPCS-computed insider-risk indicator derived from HATIS-generated raw signals, equality of VPCS inputs across RCW capital mapping and reporting, and RCW/HATIS jurisdictional correspondence; binds the validated quotes into a composite attestation chain; and produces a master hardware-attestation quote binding the chain, the consistency-result record, the committed rule-set version, and a unified federated stack output record to the hardware measurement register.

The orchestrator operates at a single venue. Consistent with the companion-system architecture, HATIS generates raw trade-integrity signals and VPCS computes the calibrated insider-risk indicator therefrom; the orchestrator consumes these as attested inputs and does not itself compute them. The orchestrator does not perform, and does not claim, the multi-exchange consolidation, cross-exchange probability fusion, or cross-exchange linkage-graph computation performed across a plurality of venues by a separate multi-exchange consolidated platform; rather, the orchestrator's per-venue master attestation quote is consumable as an input by such a platform.

### BRIEF DESCRIPTION OF THE DRAWINGS

FIG. 1 depicts the federated stack orchestrator architecture and its trust model, in subfigures FIG. 1A through FIG. 1E.

FIG. 2 depicts the end-to-end orchestration sequence, in subfigures FIG. 2A through FIG. 2E.

FIG. 3 depicts the composite attestation chain structure, in subfigures FIG. 3A through FIG. 3E.

FIG. 4 depicts the cross-layer consistency engine, in subfigures FIG. 4A through FIG. 4E.

FIG. 5 depicts the institutional output layer, in subfigures FIG. 5A through FIG. 5E.

### DETAILED DESCRIPTION OF PREFERRED EMBODIMENTS

### Definitions

As used herein, the following terms have the meanings set forth below. The definitions are inclusive and non-limiting; each term includes, but is not limited to, the described subject matter.

“Companion Application” means a hardware-attested system whose attested output is orchestrated by the orchestrator at a single venue, including but not limited to an Oracle Resolution system, a HATIS trade integrity system, a VPCS scoring engine, and an RCW regulatory-compliant wrapper.

“Composite Attestation Chain” means an ordered or tree-structured cryptographic record linking together the validated companion attestation quotes with per-companion rule-set version commitments and timestamps, including but not limited to a linear hash chain or a Merkle-tree structure whose root serves as the composite commitment.

“Cross-Layer Consistency Constraint” means a deterministic predicate, committed and sealed to the hardware identity of the hardware trusted execution environment, evaluated over the attested outputs of two or more companion applications at the single venue, including but not limited to timestamp alignment, insider-risk downweighting, fused-input equality, and jurisdictional correspondence.

“Federated Stack” means the set of companion applications orchestrated at a single regulated prediction market venue under a common root of trust through federated hardware attestation, including but not limited to Oracle Resolution, HATIS, VPCS, and RCW.

“Hardware Measurement Register” means a hardware-protected register whose contents cryptographically bind to a measured code base upon instantiation, including but not limited to platform configuration registers and equivalent measurement facilities.

“Hardware-Rooted Attestation Key” means a cryptographic key provisioned by a hardware vendor used to sign attestation quotes verifiable against a hardware-vendor attestation service, including but not limited to keys underlying Intel, AMD, ARM, or IBM attestation infrastructures.

“Insider-Risk Indicator” means a calibrated measure computed by the VPCS companion application at a configured z-score threshold from raw trade-integrity signals generated by the HATIS companion application and a calibrated probability surface, the orchestrator consuming the indicator as an attested input and not computing it.

“Master Hardware-Attestation Quote” means a hardware-attestation quote produced by the orchestrator and cryptographically signed by the hardware-rooted attestation key, binding the composite attestation chain, the consistency-result record, the committed constraint rule-set version, and the unified federated stack output record to the hardware measurement register.

“Single Regulated Prediction Market Venue” means one exchange offering prediction market or event contracts under a regulatory designation, including but not limited to a Designated Contract Market under the Commodity Exchange Act, a securities exchange under the Securities Exchange Act of 1934, or an equivalent foreign regulatory designation, as distinct from a plurality of such venues.

“Trusted Execution Environment (TEE)” means a hardware-protected execution environment providing measurement, isolation, and remote attestation, including but not limited to Intel SGX, Intel TDX, AMD SEV-SNP, ARM CCA, and IBM Secure Execution.

“Unified Federated Stack Output Record” means a record produced by the orchestrator for the single venue representing the consistency-verified consolidation of the companion attested outputs, bound into the master hardware-attestation quote.

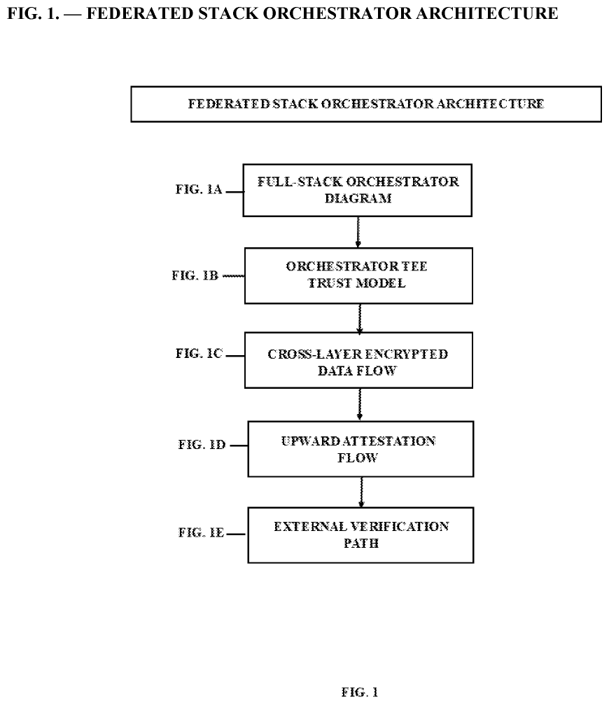

I. Orchestrator Architecture Overview. FIG. 1 depicts a hardware-attested federated stack orchestrator organized around an orchestration engine executing within a hardware trusted execution environment, with the Oracle Resolution, HATIS, VPCS, and RCW companion applications arranged around it, attested output paths flowing from each companion into the orchestrator and a unified export path flowing to institutional and regulatory consumers. The orchestrator's hardware measurement register, hardware-rooted attestation key, sealed constraint rule set, and the hardware-vendor attestation services of the orchestrator and each companion constitute the trust model (FIG. 1B). All companion channels terminate within the enclave with plaintext isolation from the host (FIG. 1C).

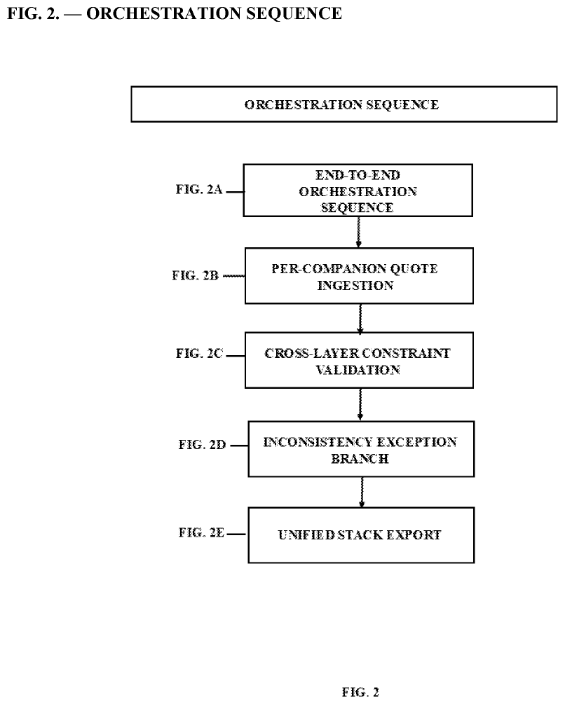

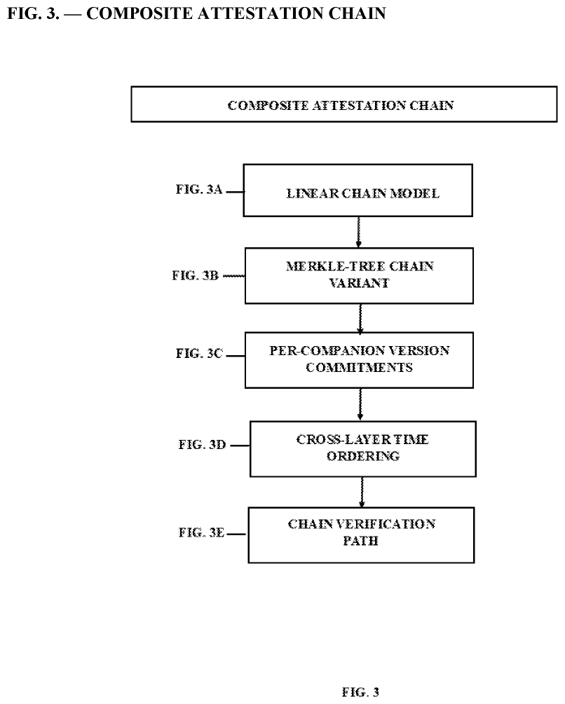

II. Companion Validation and Composite Chain. The companion validation module ingests companion attestation quotes over encrypted channels terminating within the enclave (FIG. 1C, FIG. 2B), cryptographically validates each against the corresponding hardware-vendor attestation service, and binds the validated quotes into a composite attestation chain together with per-companion rule-set version commitments and timestamps (FIG. 3A-3D). No companion attested output record is eligible for inclusion unless all applicable cross-layer consistency constraints are satisfied.

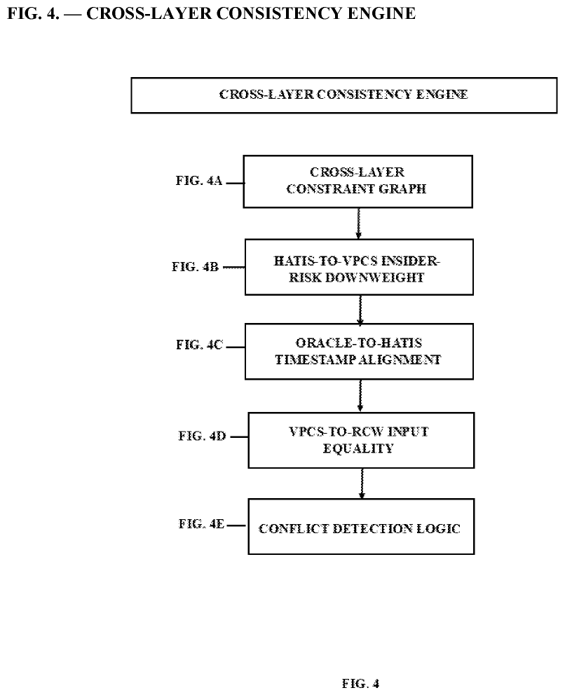

III. Cross-Layer Consistency Engine. The cross-layer consistency engine performs real-time verification against a committed constraint rule set sealed to the hardware identity of the enclave (FIG. 4A-4E), enforcing at least: alignment of Oracle resolution timestamps with HATIS-validated trade timestamps; downweighting of VPCS participant contributions for participants flagged by the VPCS-computed insider-risk indicator (computed by VPCS from HATIS-generated raw signals, consistent with the architecture in which HATIS detects and VPCS scores; the orchestrator computes neither); equality of VPCS inputs consumed by the RCW capital mapping and the RCW reporting transformation; and correspondence between RCW jurisdictional eligibility and HATIS-verified participant jurisdiction. Upon any violation the engine produces an attested inconsistency record (FIG. 2D, FIG. 4E).

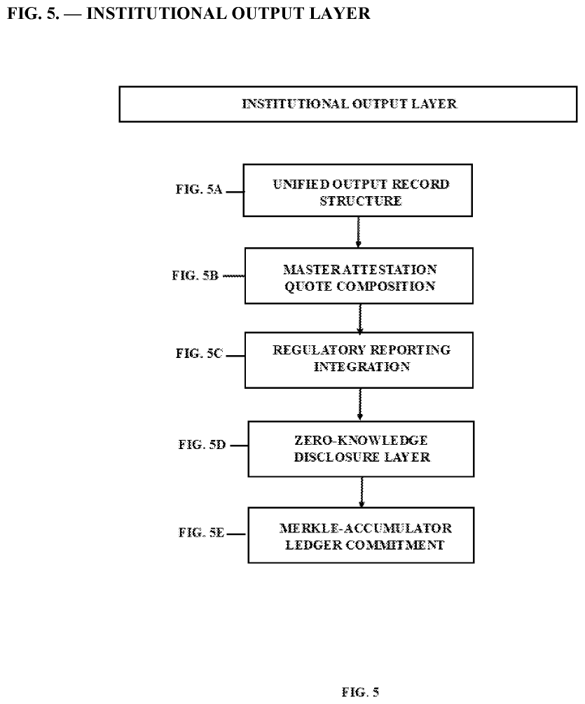

IV. Orchestration Attestation Module. The orchestration attestation module produces a master hardware-attestation quote cryptographically signed by the hardware-rooted attestation key and binding the composite attestation chain, the consistency-result record, the committed constraint rule-set version, and the unified federated stack output record to the hardware measurement register (FIG. 5A-5B). The master quote is independently verifiable by a regulator or institutional counterparty against the orchestrator's hardware-vendor attestation service and, through the composite chain, against each companion's, without reliance on the venue operator (FIG. 1E, FIG. 3E).

V. Unified Export, Ledger, and Privacy Layers. A unified export module produces composite regulatory reporting records for the single venue, each accompanied by a hardware-attestation quote binding it to the master quote (FIG. 5C). A tamper-evident master ledger organized as a Merkle accumulator maintains an append-only record of master quotes, its root periodically published to an external public commitment channel, enabling verification of temporal integrity through Merkle inclusion proofs (FIG. 5E). Optional differential-privacy and zero-knowledge layers (FIG. 5D) support privacy-preserving disclosure.

VI. Relationship to Multi-Exchange Consolidation. The orchestrator orchestrates a single venue. Its per-venue master hardware-attestation quote is consumable as an input by a multi-exchange consolidated platform that federates a plurality of orchestrators across venues; the orchestrator produces that per-venue quote and does not itself perform multi-exchange consolidation, cross-exchange probability fusion, or cross-exchange linkage-graph computation, which are functions of said separate platform.

### Enablement Examples

Example 1 (single-venue Intel SGX orchestration). Consider a single regulated prediction market venue whose federated compliance stack is orchestrated by an FSO instance executing within an Intel SGX enclave. At initialization the enclave measures the orchestration code base into a measurement register and obtains a root attestation quote via the Intel attestation service. The orchestrator ingests attested outputs from the venue's Oracle Resolution, HATIS, VPCS, and RCW companions over channels terminating within the enclave, and validates each companion quote against the Intel attestation service. The cross-layer consistency engine confirms that the Oracle resolution timestamp for contract C-1 postdates all HATIS-validated trade timestamps on C-1; that participant P-9, flagged by the VPCS-computed insider-risk indicator (z-score 3.2 above the committed threshold of 3.0, derived from HATIS raw signals), is downweighted in the VPCS contribution consumed downstream; that the VPCS output feeding the RCW capital mapping equals the VPCS output feeding RCW reporting; and that P-9's RCW jurisdictional eligibility corresponds to the HATIS-verified jurisdiction. All constraints satisfied, the orchestrator emits a master attestation quote binding the composite chain and consistency result. A regulator verifies the master quote against the Intel attestation service and, through the chain, the four companion quotes—confirming the venue's stack executed consistently without reliance on the venue operator.

Constraint-Enforcement Embodiment. In a representative failure-mode enforcement sequence illustrating the cross-layer consistency engine, the engine evaluates the committed predicate set in committed order for contract C-3 at a single venue. The Oracle-to-HATIS timestamp-alignment predicate passes. The HATIS-to-VPCS insider-risk-propagation predicate evaluates participant P- 12, flagged by the VPCS-computed insider-risk indicator (z-score 3.4 above the committed threshold of 3.0, derived from HATIS-generated raw signals), and confirms the required downweight is applied. The VPCS-to-RCW input-equality predicate then compares the VPCS output digest consumed by the RCW capital mapping against the VPCS output digest consumed by the RCW reporting transformation and detects inequality (capital-mapping digest 0x4c2a..., reporting digest 0x4c2b...), indicating that RCW consumed divergent VPCS inputs for capital and reporting. Upon this predicate failure the engine halts inclusion of the implicated RCW attested output record in the composite attestation chain and causes the orchestration attestation module to emit an attested inconsistency record identifying the failed VPCS-to-RCW input-equality predicate, the RCW and VPCS companions, the divergent digests, and the committed constraint rule-set version. A degraded master hardware-attestation quote is produced binding the inconsistency record rather than a clean unified output, such that a relying regulator verifying the master quote observes the specific cross-layer inconsistency without reliance on the venue operator. This enforcement behavior is deterministic and bound, by the committed constraint rule-set version, into the master hardware-attestation quote.

Example 2 (multi-vendor companions with detected cross-layer inconsistency). Consider a venue operating its companions across heterogeneous trusted execution environments—Oracle Resolution and HATIS on AMD SEV-SNP, VPCS and RCW on Intel TDX—with the orchestrator applying a multi-vendor attestation policy provisioned at enclave initialization. The orchestrator validates the AMD-attested companion quotes against AMD's attestation service and the Intel-attested companion quotes against Intel's, then evaluates the cross-layer constraints. The engine detects a violation: the Oracle resolution timestamp for contract C-2 predates a HATIS-validated trade timestamp on C-2, indicating a resolution-before-trade inconsistency. Rather than failing silently, the orchestrator produces an attested inconsistency record identifying the violated Oracle/HATIS timestamp-alignment constraint, the companions and contract involved, the disputed timestamps, and the committed rule-set version, and exports it as a first-class verifiable regulatory output alongside a degraded master quote. The venue's compliance workflow ingests the inconsistency record, and a regulator verifies it without instantiating a trusted execution environment of its own.

VII. Alternative Embodiments. The orchestrator may be practiced on any computer hardware providing the trusted-execution-environment properties described herein, and supports additional and successor TEE implementations and multi-vendor attestation policies. The committed constraint rule set is illustrative and non-limiting; additional embodiments enforce further deterministic cross-layer predicates. The disclosure herein supports, and the applicant reserves the right to pursue in one or more continuation or divisional applications, claims of broader or differing scope, including without limitation claims directed to single-venue orchestration of regulated electronic market compliance stacks generally and claims directed to the cross-layer consistency mechanism independent of the prediction-market context. The foregoing embodiments are illustrative and non-limiting.

What is claimed is:

1. A hardware-attested federated stack orchestrator for orchestrating, at a single regulated prediction market venue, a plurality of companion compliance systems, comprising: at least one orchestration engine configured to execute within a hardware trusted execution environment having a hardware measurement register and a hardware-rooted attestation key provisioned by a hardware vendor, the hardware trusted execution environment configured to load a measured orchestration code base such that the contents of the hardware measurement register cryptographically bind to the loaded code base upon instantiation; a plurality of companion intake interfaces configured to ingest into the hardware trusted execution environment, over encrypted channels terminating at endpoints within the hardware trusted execution environment, attested output records from each of an Oracle Resolution companion application, a hardware-attested trade integrity system (HATIS) companion application, a verified prediction confidence scoring (VPCS) companion application, and a regulatory-compliant wrapper (RCW) companion application, all operating at the single regulated prediction market venue, wherein the HATIS companion application generates raw trade-integrity signals and the VPCS companion application computes an insider-risk indicator at a configured z-score threshold from said signals and a calibrated probability surface; a companion validation module executing within the hardware trusted execution environment and configured to cryptographically validate each companion attestation quote against the corresponding hardware-vendor attestation service and to bind the validated attestation quotes into a composite attestation chain together with per-companion rule-set version commitments and timestamps; a cross-layer consistency engine executing within the hardware trusted execution environment and configured to perform real-time cross-layer consistency verification against a committed constraint rule set sealed to the hardware identity of the hardware trusted execution environment, said verification enforcing at least alignment of Oracle resolution timestamps with HATIS-validated trade timestamps, downweighting of VPCS participant contributions for participants flagged by the VPCS-computed insider-risk indicator derived from the HATIS-generated raw trade-integrity signals, equality of VPCS inputs to an RCW capital mapping and an RCW reporting transformation, and correspondence between RCW jurisdictional eligibility and HATIS-verified participant jurisdiction, and configured to produce a cross-layer consistency-result record; and an orchestration attestation module configured to produce a master hardware-attestation quote cryptographically signed by the hardware-rooted attestation key and binding the composite attestation chain, the cross-layer consistency-result record, the committed constraint rule-set version, and a unified federated stack output record for the single venue to the hardware measurement register, wherein no companion attested output record is eligible for inclusion in the composite attestation chain unless all cross-layer consistency constraints applicable to that output record are satisfied, and wherein the master hardware-attestation quote is independently verifiable by a regulator or institutional counterparty against hardware-vendor attestation services of the orchestrator and each companion application without participation of, or reliance on representations by, the prediction market exchange operator.

2. A method of federated stack orchestration at a single regulated prediction market venue, the method comprising: loading a measured orchestration code base into a hardware trusted execution environment having a hardware measurement register and a hardware-rooted attestation key; ingesting, over encrypted channels terminating at endpoints within the hardware trusted execution environment, attested output records from each of the Oracle Resolution companion application, the HATIS companion application, the VPCS companion application, and the RCW companion application, wherein the HATIS companion application generates raw trade-integrity signals and the VPCS companion application computes an insider-risk indicator at a configured z-score threshold from said signals and a calibrated probability surface; cryptographically validating each companion attestation quote against the corresponding hardware-vendor attestation service; performing real-time cross-layer consistency verification against a committed constraint rule set sealed to the hardware identity of the hardware trusted execution environment, wherein, upon failure of any constraint, the hardware trusted execution environment halts inclusion of the implicated companion attested output record in the composite attestation chain such that non-conforming companion output is technically precluded from entering the attested chain, said verification enforcing at least alignment of Oracle resolution timestamps with HATIS-validated trade timestamps, downweighting of VPCS participant contributions for participants flagged by the VPCS-computed insider-risk indicator derived from the HATIS-generated raw trade-integrity signals, equality of VPCS inputs to RCW capital mapping and RCW reporting, and correspondence between RCW jurisdictional eligibility and HATIS-verified participant jurisdiction; cryptographically linking the validated attestation quotes into a composite attestation chain together with per-companion rule-set version commitments and timestamps; producing a master hardware-attestation quote cryptographically signed by the hardware-rooted attestation key and binding the composite attestation chain, the consistency-result record, the committed constraint rule-set version, and a unified federated stack output record to the hardware measurement register; and exporting the unified federated stack output record, the master hardware-attestation quote, and, upon identification of one or more violations, an attested inconsistency record, in a form independently verifiable by a regulator or institutional counterparty against hardware-vendor attestation services of the orchestrator and each companion application without reliance on the prediction market exchange operator.

3. A non-transitory computer-readable medium storing program instructions that, when executed within a hardware trusted execution environment of a computer system having a hardware measurement register and a hardware-rooted attestation key, cause the hardware trusted execution environment to perform operations comprising: loading a measured orchestration code base such that the contents of the hardware measurement register cryptographically bind to the loaded code base upon instantiation; ingesting attested output records from Oracle Resolution, HATIS, VPCS, and RCW companion applications operating at a single regulated prediction market venue; cryptographically validating each companion attestation quote against the corresponding hardware-vendor attestation service; performing cross-layer consistency verification against a committed constraint rule set sealed to the hardware identity of the hardware trusted execution environment, wherein no companion attested output record is eligible for inclusion in a composite attestation chain unless all cross-layer consistency constraints applicable to that output record are satisfied, such that the hardware trusted execution environment technically precludes non-conforming companion output from entering the composite attestation chain and, upon any constraint failure, produces an attested inconsistency record as a concrete operational result, producing a cross-layer consistency-result record; binding the validated attestation quotes into the composite attestation chain together with per-companion rule-set version commitments and timestamps; and producing a master hardware-attestation quote cryptographically signed by the hardware-rooted attestation key and binding the composite attestation chain, the consistency-result record, the committed constraint rule-set version, and a unified federated stack output record to the hardware measurement register, independently verifiable against a hardware-vendor attestation service without participation of, or reliance on representations by, the prediction market exchange operator, wherein any modification of any constituent companion attested output record, of the composite attestation chain, or of the unified federated stack output record invalidates verification of the master hardware-attestation quote.

4. The system of claim 1, wherein the hardware trusted execution environment comprises at least one of Intel Software Guard Extensions, Intel Trust Domain Extensions, AMD Secure Encrypted Virtualization with Secure Nested Paging, ARM Confidential Compute Architecture, IBM Secure Execution for Linux, or any equivalent or successor confidential computing architecture providing hardware-rooted measurement, isolation, and remote attestation.

5. The system of claim 1, wherein the cross-layer consistency engine further enforces, for each participant flagged by the VPCS-computed insider-risk indicator, a downweighting of that participant's contribution across the unified federated stack output record for the single venue, the insider-risk indicator being computed by the VPCS companion application and not by the orchestrator, and the raw trade-integrity signals being generated by the HATIS companion application and not by the orchestrator.

6. The system of claim 1, further comprising a tamper-evident master ledger organized as a Merkle accumulator whose root is periodically committed to an external public commitment channel comprising at least one of a public blockchain, a regulator-operated commitment endpoint, and a consortium-operated commitment channel.

7. The system of claim 1, wherein the orchestration attestation module is further configured to produce an attested inconsistency record upon identification of one or more violations of the committed constraint rule set, identifying the violated constraint, the companion applications and participants involved, the attested values in dispute, and the committed constraint rule-set version, exported as a first-class verifiable regulatory output.

8. The system of claim 1, further comprising a unified export module executing within the hardware trusted execution environment and configured to produce, for the single venue, composite regulatory reporting records drawing upon the attested outputs of the four companion applications, accompanied by a hardware-attestation quote binding each composite report to the master hardware-attestation quote.

9. The system of claim 1, further comprising a differential-privacy module configured to apply Laplace or Gaussian noise with committed epsilon and delta parameters to aggregate single-venue stack outputs prior to export, with the committed noise parameters bound into the master hardware-attestation quote.

10. The system of claim 1, wherein the orchestrator operates as the unifying orchestration layer of a four-system hardware-attested stack at the single regulated prediction market venue, comprising the Oracle Resolution, HATIS, VPCS, and RCW companion applications sharing a common root of trust through federated hardware attestation, and wherein the orchestrator orchestrates a single venue and does not perform, and does not claim, multi-exchange consolidation, cross-exchange probability fusion, or cross-exchange linkage-graph computation across a plurality of venues.

11. The system of claim 1, wherein the master hardware-attestation quote produced for the single venue is consumable as a per-venue input by a multi-exchange consolidated platform that federates a plurality of such orchestrators across a plurality of venues, the orchestrator producing said per-venue master hardware-attestation quote and not itself performing the multi-exchange consolidation.

12. The method of claim 2, wherein the cross-layer consistency verification further produces an enumerated violations record upon identification of any violation, and wherein the unified federated stack output record pertains to the single regulated prediction market venue.

13. The method of claim 2, further comprising committing the master hardware-attestation quote to a tamper-evident master ledger organized as a Merkle accumulator whose root is periodically published to an external public commitment channel, and enabling a relying party to verify the temporal integrity of a past master hardware-attestation quote through a Merkle inclusion proof.

14. The method of claim 2, further comprising generating and exporting, together with the master hardware-attestation quote, a zero-knowledge proof attesting that the unified federated stack output record was produced by the committed orchestration code base under the committed constraint rule set on the committed companion attested inputs, without disclosing per-participant data.

15. The method of claim 2, further comprising generating composite regulatory reporting records for the single venue configured to be usable in systems designed to support compliance with applicable regulatory reporting requirements, and producing a hardware-attestation quote binding each composite report to the master hardware-attestation quote.

16. The system of claim 1, wherein the cross-layer consistency engine is configured to evaluate the committed constraint rule set as a deterministic ordered set of predicates comprising, in a committed evaluation order: (i) an Oracle-to-HATIS timestamp-alignment predicate requiring that an Oracle resolution timestamp for a contract postdate every HATIS-validated trade timestamp on that contract; (ii) a HATIS-to-VPCS insider-risk-propagation predicate requiring that a participant flagged by the VPCS-computed insider-risk indicator be downweighted in the VPCS contribution consumed downstream; (iii) a VPCS-to-RCW input-equality predicate requiring that the VPCS output consumed by the RCW capital mapping equal the VPCS output consumed by the RCW reporting transformation; and (iv) an RCW-to-HATIS jurisdictional-correspondence predicate requiring that RCW jurisdictional eligibility correspond to the HATIS-verified participant jurisdiction; and wherein, upon failure of any predicate, the cross-layer consistency engine halts inclusion of the implicated companion attested output record in the composite attestation chain and causes the orchestration attestation module to emit an attested inconsistency record identifying the failed predicate, such that the deterministic ordered predicate set and its committed evaluation order are bound, by the committed constraint rule-set version, into the master hardware-attestation quote.

17. The method of claim 2, wherein the master hardware-attestation quote and the attested inconsistency record are each formatted such that a relying party comprising a regulator or institutional counterparty verifies the master hardware-attestation quote against a hardware-vendor attestation service of the orchestrator and, through the composite attestation chain, against the hardware-vendor attestation services of each companion application, thereby confirming that the unified federated stack output was produced by the measured orchestration code base on the attested companion inputs without participation of, or reliance on representations by, the prediction market exchange operator and without the relying party instantiating a hardware trusted execution environment at infrastructure of the relying party.

18. The non-transitory computer-readable medium of claim 3, wherein the master hardware-attestation quote comprises: (a) the contents of the hardware measurement register; (b) a hardware-vendor-signed chain-of-trust certificate of the orchestrator; (c) a composite attestation chain root; (d) per-companion quote references including companion identifier, quote hash, per-companion vendor attestation reference, per-companion rule-set version, and timestamp; (e) the committed constraint rule-set version; (f) the consistency-result record; (g) unified federated stack output digests; and (h) a signature produced using the hardware-rooted attestation key.

19. The non-transitory computer-readable medium of claim 3, wherein the operations further comprise providing the unified federated stack output record and the master hardware-attestation quote to a compliance workflow of the single regulated prediction market venue, the venue relying upon the independently verifiable master hardware-attestation quote to evidence integrity of its federated stack execution to a regulator or institutional counterparty without reliance on representations of the venue operator.

20. The non-transitory computer-readable medium of claim 3, wherein the operations further comprise dynamic reconfiguration of orchestrated companion applications based on attested outputs, including suspension or degradation of the master hardware-attestation quote upon detection of a companion application unavailability or attestation failure, wherein the master hardware-attestation quote cannot be reproduced outside the hardware trusted execution environment without invalidating the quote and any modification to a companion output outside the orchestrator invalidates the master hardware-attestation quote.
